(19) United States
(12) Patent Application Publication
(10) Pub. No.: US 2026/0241853 A1
(43) Pub. Date: Aug. 20, 2026

(54) HEADLIGHT CONTROL APPARATUS

(71) Applicant: SUBARU CORPORATION, Tokyo (JP)

(72) Inventor: Shinya KUDO, Tokyo (JP)

(21) Appl. No.: 19/452,989

(22) Filed: Jan. 20, 2026

(30) Foreign Application Priority Data
Feb. 18, 2025 (JP) 2025-024571

(51) Int. Cl. B60Q 1/14; B60Q 9/00; B62D 15/02; H05B 47/115

(52) U.S. Cl. CPC B60Q 1/143; B60Q 9/00; B62D 15/0265; H05B 47/115; B60Q 2300/23; B60Q 2300/45

(57) ABSTRACT

A headlight control apparatus includes a frontal imager, a driver imager, one or more headlights, a notifier, and a headlight controller. The frontal imager monitors a pedestrian in a frontal area ahead of a vehicle. The driver imager recognizes a line of sight of a driver. The one or more headlights irradiate the frontal area by emitting irradiation beams irradiating different directions at the same time. The headlight controller controls the one or more headlights, based on data acquired from the frontal imager and the driver imager. When the line of sight of the driver is directed toward the pedestrian and the pedestrian has recognized the vehicle, or when the line of sight of the driver has shifted from the notifier to the frontal area and the pedestrian has recognized the vehicle, the headlight controller sets an irradiation beam of any headlight directed toward the pedestrian to a low beam.

### CROSS-REFERENCE TO RELATED APPLICATIONS

The present application claims priority from Japanese Patent Application No. 2025-024571 filed on February 18, 2025, the entire contents of which are hereby incorporated by reference.

### BACKGROUND

The disclosure relates to a headlight control apparatus.

Recent vehicles such as automobiles include an apparatus that detects light from a preceding vehicle and the presence of an obstacle or a pedestrian and controls a high-beam irradiation range to reduce dazzling of a driver who drives the preceding vehicle or an oncoming vehicle.

The vehicle including the headlight control apparatus described above emits a high beam from a headlight to a pedestrian until the vehicle detects the pedestrian at an early stage of approaching to the pedestrian or until a driver who drives the vehicle recognizes the presence of the pedestrian.

It is generally recommended for the vehicle to switch the headlight from the high beam to a low beam after the pedestrian is detected or the driver recognizes the presence of the pedestrian to eliminate dazzling of the pedestrian caused by the high beam.

As an example of the headlight control technology described above, Japanese Unexamined Patent Application Publication (JP-A) No. 2014-4968 discloses a light distribution controller including a pedestrian detection unit, a determination unit, and an illumination controller. The pedestrian detection unit detects a pedestrian in a predetermined area ahead of a vehicle, based on an image captured by an infrared camera. The determination unit determines whether a driver notices the pedestrian when the pedestrian detection unit has detected the pedestrian in the predetermined area. The illumination controller causes the headlight to be lit with a light distribution pattern without a restriction on illumination of the pedestrian until the determination unit determines that the driver notices the pedestrian, and causes the headlight to be lit with a light distribution pattern having a restriction on illumination of a body member of the pedestrian after the determination unit determines that the driver notices the pedestrian.

The technology disclosed in JP-A No. 2014-4968 controls the headlight, based on the result of determination as to whether the driver has noticed the pedestrian detected by the infrared camera.

However, the technology disclosed in JP-A No. 2014-4968 fails to determine whether the pedestrian has recognized the vehicle taking into consideration a position or movement of the pedestrian.

It is desirable to provide a headlight control apparatus that reduces unnecessary irradiation of a pedestrian present in front of a vehicle in the night, and secure a safety for movement of the pedestrian.

### SUMMARY

An aspect of the disclosure provides a headlight control apparatus configured to be applied to a vehicle. The headlight control apparatus includes a frontal imager, a driver imager, one or more headlights, a notifier, and a headlight controller. The frontal imager is configured to monitor a pedestrian and a structure present in a frontal area ahead of the vehicle. The driver imager is configured to recognize a line of sight of a driver who drives the vehicle. The one or more headlights are configured to irradiate the frontal area by emitting irradiation beams irradiating different directions at a same time. The irradiation beams are switchable between a high beam and a low beam. The notifier is configured to notify the driver that the pedestrian has been detected in the frontal area. The headlight controller is configured to control the one or more headlights and the notifier, based on data acquired from the frontal imager and data acquired from the driver imager. The headlight controller is configured to, when the headlight controller determines that the line of sight of the driver is directed toward the pedestrian, based on the data acquired from the driver imager, and that the pedestrian has recognized the vehicle, based on the data acquired from the frontal imager, or when the headlight controller determines that the line of sight of the driver has shifted from the notifier to the frontal area, based on the data acquired from the driver imager, and that the pedestrian has recognized the vehicle, based on the data acquired from the frontal imager, set an irradiation beam of any headlight directed toward the pedestrian out of the one or more headlights to the low beam.

An aspect of the disclosure provides a headlight control apparatus configured to be applied to a vehicle. The headlight control apparatus includes a frontal imager, a driver imager, one or more headlights, a notifier, and a headlight controller. The frontal imager is configured to monitor a pedestrian and a structure present in a frontal area ahead of the vehicle. The driver imager is configured to recognize a line of sight of a driver who drives the vehicle. The one or more headlights are configured to irradiate the frontal area by emitting irradiation beams irradiating different directions at a same time. The irradiation beams are switchable between a high beam and a low beam. The notifier is configured to notify the driver that the pedestrian has been detected in the frontal area. The headlight controller is configured to control the one or more headlights and the notifier, based on data acquired from the frontal imager and data acquired from the driver imager. The headlight controller includes one or more processors and one or more memories communicably coupled to the one or more processors. The one or more memories include a storage configured to store the data acquired from the frontal imager and the data acquired from the driver imager. The one or more processors are configured to, when the headlight controller determines that the line of sight of the driver is directed toward the pedestrian, based on the data acquired from the driver imager, and that the pedestrian has recognized the vehicle, based on the data acquired from the frontal imager, or when the headlight controller determines that the line of sight of the driver has shifted from the notifier to the frontal area, based on the data acquired from the driver imager, and that the pedestrian has recognized the vehicle, based on the data acquired from the frontal imager, set an irradiation beam of any headlight directed toward the pedestrian out of the one or more headlights to the low beam.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a schematic view of a vehicle including a headlight control apparatus according to one example embodiment of the disclosure.

FIG. 2 is a cross-sectional view of a headlight taken along a line a-a in FIG. 1.

FIG. 3 is a plan view of the vehicle illustrating irradiation beams emitted from the headlights under the control by the headlight control apparatus as viewed from above the vehicle.

FIG. 4A is a side view of the vehicle illustrating a low beam emitted from the headlight under the control by the headlight control apparatus illustrated in FIG. 1.

FIG. 4B is a side view of the vehicle illustrating a high beam emitted from the headlight under the control by the headlight control apparatus illustrated in FIG. 1.

FIG. 5A is a schematic diagram illustrating a distance between the vehicle including the headlight control apparatus illustrated in FIG. 1 and a pedestrian.

FIG. 5B is a schematic diagram illustrating a distance between the vehicle and the pedestrian shorter than that illustrated in FIG. 5A.

FIG. 6 is a graph illustrating a relation of the distance between the vehicle and the pedestrian with determination time when a headlight controller in the headlight control apparatus illustrated in FIG. 1 recognizes the pedestrian.

FIG. 7 is a block diagram illustrating the headlight control apparatus illustrated in FIG. 1.

FIG. 8 is a flowchart of a process to be performed by the headlight controller in the headlight control apparatus illustrated in FIG. 1.

FIG. 9 is a flowchart of a process to be performed by the headlight controller in the headlight control apparatus illustrated in FIG. 1 in accordance with a frontal condition ahead of the vehicle.

FIG. 10 is a block diagram illustrating a headlight control apparatus according to one example embodiment of the disclosure.

FIG. 11 is a flowchart of a process to be performed by a headlight controller in the headlight control apparatus illustrated in FIG. 10.

### DETAILED DESCRIPTION

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

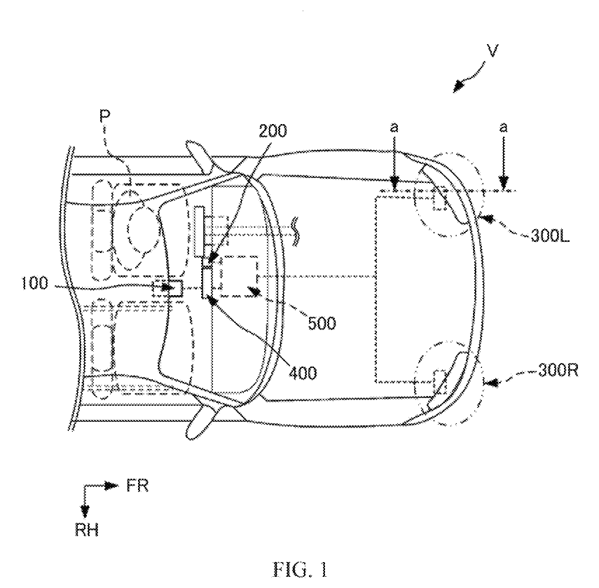

A description is given, with reference to FIGS. 1 to 11, of a headlight control apparatus 10 and a headlight control apparatus 10A.

It is to be noted that an arrow FR illustrated in the drawings as needed may indicate an advancing direction of a vehicle V illustrated in FIG. 1, an arrow UP may indicate an up direction with respect to the vehicle V, and an arrow RH may indicate a right direction with respect to the vehicle V directed in the advancing direction.

In the following description, an up-down direction, a front-back direction, and a left-right direction correspond to a vertical direction, a longitudinal direction, and a lateral direction with respect to the vehicle directed in the advancing direction, respectively, unless otherwise noted.

### First Example Embodiment

A description is given, with reference to FIGS. 1 to 9, of the headlight control apparatus 10 according to the present example embodiment.

### Headlight Control Apparatus 10

As illustrated in FIG. 1, the headlight control apparatus 10 in the vehicle V includes a frontal imager 100, a driver imager 200, headlights 300L and 300R (hereinafter collectively referred to as a headlight 300), a notifier 400, and a headlight controller 500.

The frontal imager 100, the driver imager 200, the headlight 300, and the notifier 400 may be coupled to the headlight controller 500.

### Frontal Imager 100

The frontal imager 100 may be, for example, a camera device directed in the advancing direction of the vehicle V and configured to capture an image of a frontal area ahead of the vehicle V, and may monitor a pedestrian PD and a structure present in the frontal area.

The frontal imager 100 may acquire data on the image of the frontal area, and send the image data thus acquired to the headlight controller 500.

The frontal imager 100 may be disposed at a position on an upper frontal portion of a vehicle compartment of the vehicle V near a windshield.

The frontal imager 100 may be a stereo camera including a plurality of cameras or may be a monocular camera.

### Driver Imager 200

The driver imager 200 may be an in-vehicle camera configured to capture an image of movement of a specific part of a driver P who drives the vehicle V, such as the eyes or a hand, and an image of a driver's seat or peripheral devices disposed around the driver's seat.

The driver imager 200 may be disposed in an instrument panel installed in front of the driver's seat of the vehicle V, for example. The driver imager 200 may capture an image of the driver's seat and the driver P from a position in front of the driver's seat, and send the captured image to the headlight controller 500.

In some embodiments, the driver imager 200 may capture an image of a specific part of the driver P, such as the eyes or a hand, and send the captured image to the headlight controller 500.

### Headlight 300

The headlight 300 (the headlights 300L and 300R) emits irradiation beams toward the frontal area ahead of the vehicle V to irradiate different directions at the same time.

One or more headlights 300 may be provided on a front side of the vehicle V.

The headlight 300 is switchable between a high beam HB and a low beam LB.

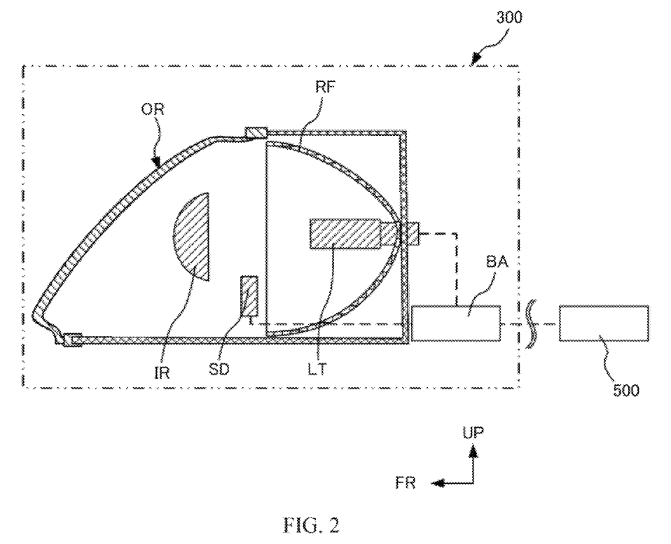

As illustrated in FIG. 2, for example, the headlight 300 may include an outer lens OR disposed on a front side of the vehicle V.

Behind the outer lens OR in a back direction with respect to the vehicle V, a reflector RF, an inner lens, a light source LT, a shade SD, and a light distribution actuator BA may be disposed.

Used as the light source LT may be an electric bulb such as filament lamp or a LED.

In some embodiments, a plurality of the reflectors RF, a plurality of the inner lenses IR, a plurality of the light sources LT, and a plurality of the shades SD may be provided.

The headlight 300 may emit irradiation beams in multiple directions by performing control to operate the light source LT and the shade SD via the light distribution actuator BA, based on control data received from the headlight controller 500 described below.

The light distribution actuator BA may change a lighting position, brightness, or an angle of the light source LT, based on the control data received from the headlight controller 500, for example.

The light distribution actuator BA may move the shade SD in the up-down direction, based on the control data received from the headlight controller 500, for example.

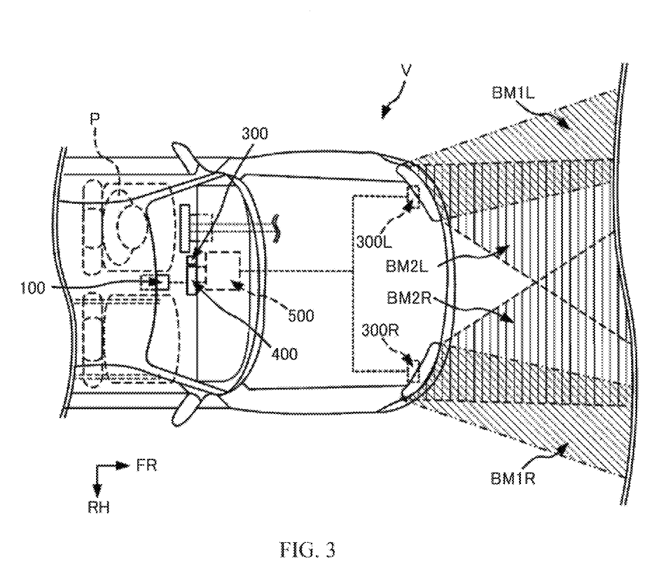

As illustrated in FIG. 3, for example, the headlight 300 may emit a left irradiation beam BM1L to irradiate a left-side area outside the vehicle V, a right irradiation beam BM1R to irradiate a right-side area outside the vehicle V, and a front irradiation beam BM2 (front irradiation beams BM2L and BM2R) to irradiate the frontal area ahead of the vehicle V.

The left irradiation beam BM1L, the right irradiation beam BM1R, and the front irradiation beam BM2 may be emitted at the same time.

The left irradiation beam BM1L, the right irradiation beam BM1R, and the front irradiation beam BM2 may be each switchable between the high beam HB and the low beam LB, independently from each other.

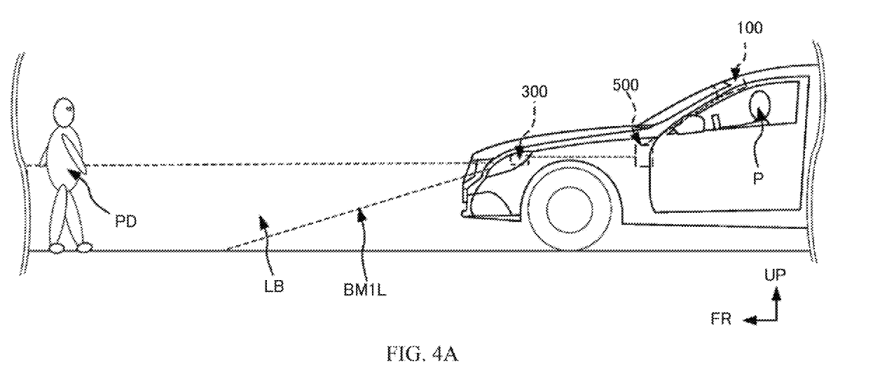

When the headlight 300 is set to the low beam LB, the headlight 300 may emit the irradiation beams in a lower front direction from the vehicle V, as illustrated in FIG. 4A.

At this time, the headlight 300 may emit each irradiation beam in such a direction that a field of view of the frontal area ahead of the vehicle V is secured and that dazzling of a driver who drives an oncoming vehicle or a pedestrian PD caused by the irradiation is prevented.

In contrast, when the headlight 300 is set to the high beam HB, the headlight 300 may emit irradiation beams farther away than the low beam LB, as illustrated in FIG. 4B.

When the headlight 300 is set to the low beam LB, the headlight 300 may be controlled by the headlight controller 500 to irradiate the frontal area in a distance of 40 meters ahead of the vehicle V, for example.

When the headlight 300 is set to the high beam HB, the headlight 300 may be controlled by the headlight controller 500 to irradiate the frontal area in a distance of 100 meters ahead of the vehicle V, for example.

### Notifier 400

The notifier 400 notifies the driver P that a pedestrian PD has been detected in the frontal area ahead of the vehicle V.

In some embodiments, the notifier 400 may be a display.

In some embodiments, the notifier 400 may notify the driver P that a pedestrian PD has been detected in the frontal area by outputting a sound or displaying an image, based on the control data received from the headlight controller 500.

The notifier 400 may be coupled to the headlight controller 500.

### Headlight Controller 500

The headlight controller 500 controls the headlight 300, based on data acquired from the frontal imager 100 and data acquired from the driver imager 200.

The headlight controller 500 may acquire and analyze data on the frontal area ahead of the vehicle V, based on the image data received from the frontal imager 100.

Non-limiting examples of the data on the frontal area may include data on size, position, and movement of a pedestrian PD or a structure that is present in the frontal area and that the vehicle V is to avoid approaching.

The headlight controller 500 may acquire and analyze data on movement of the driver P, based on the image data received from the driver imager 200.

Non-limiting examples of the data on movement of the driver P may include data on facial orientation and eye direction of the driver P.

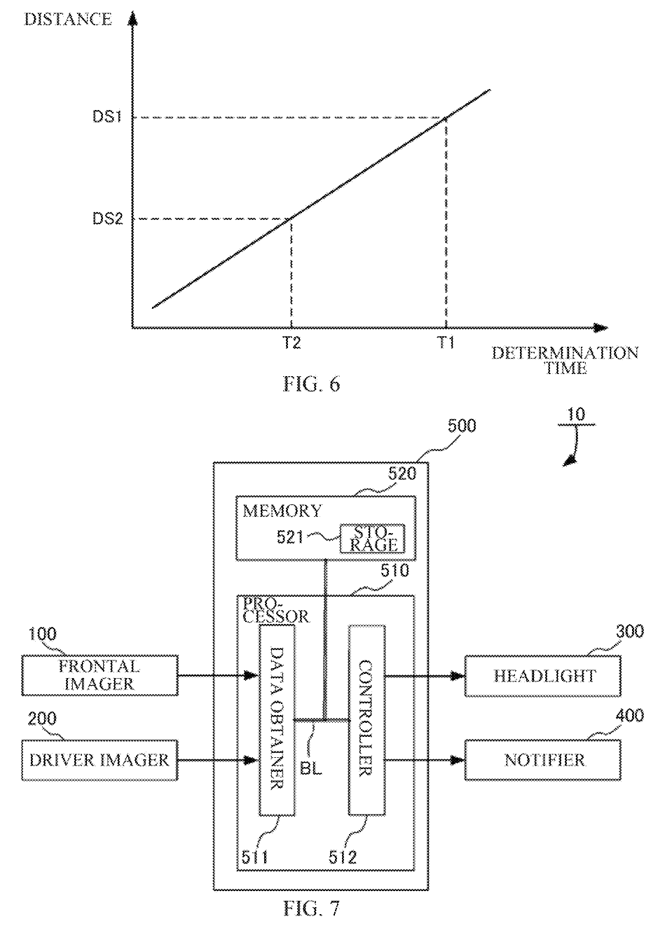

As illustrated in FIG. 7, the headlight controller 500 may be coupled to the frontal imager 100, the driver imager 200, the headlight 300, and the notifier 400.

The headlight controller 500 includes one or more processors 510 and one or more memories 520 communicably coupled to the one or more processors 510. The processor 510 and the memory 520 may be coupled to each other with a bus line BL.

The processor 510 may control the headlight 300, based on a control program held in the memory 520.

### Processor 510

The processor 510 may include a data obtainer 511 and a controller 512.

The data obtainer 511, the controller 512, and the memory 520 may be coupled to one another with the bus line BL.

The data obtainer 511 may acquire data from the frontal imager 100 and the driver imager 200, and store the data thus acquired in the memory 520.

The data obtainer 511 may be coupled to the frontal imager 100 and the driver imager 200.

The controller 512 may determine whether a line of sight of the driver P is directed toward the pedestrian PD, based on the data acquired from the driver imager 200.

In some embodiments, the controller 512 may determine whether the face or line of sight of the driver P is directed toward the pedestrian PD by analyzing the image data received from the driver imager 200. If the controller 512 determines that the face or line of sight of the driver P is directed toward the pedestrian PD, the controller 512 may determine that the driver P has recognized the pedestrian PD.

The controller 512 may determine whether the line of sight of the driver P has shifted from the notifier 400 to the frontal area, based on the data acquired from the driver imager 200.

In some embodiments, the controller 512 may analyze the image data received from the driver imager 200 to acquire the data on eye direction of the driver P.

If the controller 512 determines that the line of sight of the driver P has shifted from the notifier 400 to the frontal area, based on the data on eye direction of the driver P, the controller 512 may determine that the driver P has recognized the pedestrian PD.

If the controller 512 determines that the line of sight of the driver P is directed toward the pedestrian PD or that the line of sight of the driver P has shifted from the notifier 400 to the frontal area, the controller 512 may determine that the driver P has recognized the pedestrian PD.

The controller 512 may determine whether the pedestrian PD has recognized the vehicle V, based on the data received from the frontal imager 100.

In some embodiments, the controller 512 may determine that the pedestrian PD has recognized the vehicle V when the face of the pedestrian PD is directed toward the vehicle V or when the pedestrian PD has moved toward a road end.

If the controller 512 determines that the driver P has recognized the pedestrian PD and that the pedestrian PD has recognized the vehicle V, the controller 512 may send the headlight 300 data indicating that the headlight 300 directed toward the pedestrian PD is to be set to the low beam LB.

The controller 512 may acquire the data on the frontal area ahead of the vehicle V from the frontal imager 100, and control the headlight 300 in accordance with a condition in the frontal area ahead of the vehicle V.

The controller 512 may acquire data on a distance between the pedestrian PD and the vehicle V, based on the data acquired from the frontal imager 100.

In accordance with the distance between the pedestrian PD and the vehicle V, the controller 512 may set determination time T, which is time in which the controller 512 determines whether the line of sight of the driver P is directed toward the pedestrian PD, or in which the controller 512 determines whether the line of sight of the driver P has shifted from the notifier 400 to the frontal area.

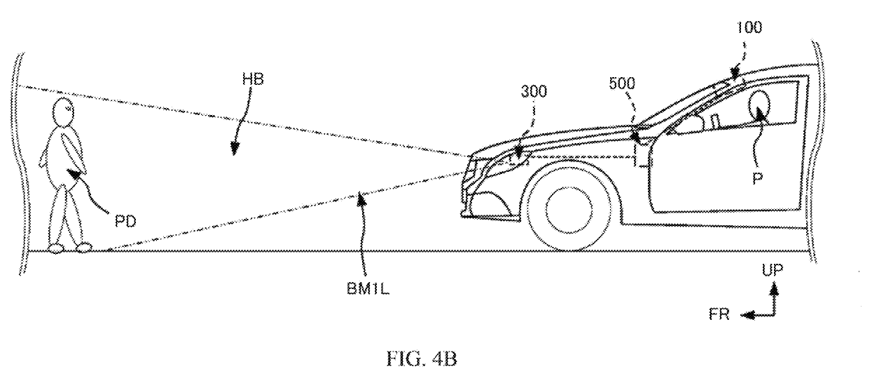

In some embodiments, as illustrated in FIGS. 5A and 5B, the controller 512 may acquire the data on the distance between the pedestrian PD and the vehicle V, based on the data acquired from the frontal imager 100.

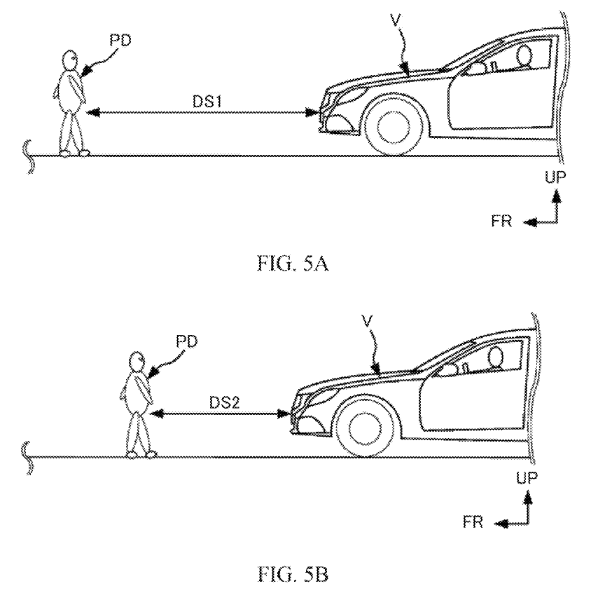

Non-limiting examples of the data on the distance between the pedestrian PD and the vehicle V may include a distance DS1 or a distance DS2, as illustrated in FIGS. 5A and 5B and FIG. 6.

The controller 512 may set the determination time T in accordance with the distance between the pedestrian PD and the vehicle V, based on the data on the distance between the pedestrian PD and the vehicle V.

At this time, the controller 512 may set the determination time T shorter as the pedestrian PD comes closer to the vehicle V, for example.

In some embodiments, as illustrated in FIG. 6, the controller 512 may set the determination time T to determination time T1 when the distance between the vehicle V and the pedestrian PD is the distance DS1.

The controller 512 may determine whether the line of sight of the driver P is directed toward the pedestrian PD or whether the line of sight of the driver P has shifted from the notifier 400 to the frontal area, in the determination time T1.

The controller 512 may set the determination time T to determination time T2, which is earlier than the determination time T1, when the distance between the vehicle V and the pedestrian PD is the distance DS2, which is shorter than the distance DS1.

The controller 512 may determine whether the line of sight of the driver P is directed toward the pedestrian PD or whether the line of sight of the driver P has shifted from the notifier to the frontal area, in the determination time T2.

If the controller 512 determines that the line of sight of the driver P is directed toward the pedestrian PD or that the line of sight of the driver P has shifted from the notifier 400 to the frontal area, the controller 512 may determine that the driver P has recognized the pedestrian PD.

If the controller 512 determines that the driver P has recognized the pedestrian PD and that the pedestrian PD has recognized the vehicle V, the controller 512 may send the headlight 300 the data indicating that the headlight 300 directed toward the pedestrian PD is to be set to the low beam LB.

If the controller 512 determines that the pedestrian PD is crossing a road, the controller 512 may switch the headlight 300 directed toward the pedestrian PD to the low beam LB, and thereafter repeatedly switch the headlight 300 between the high beam HB and the low beam LB at a constant frequency.

The controller 512 may analyze the image data received from the frontal imager 100 to acquire data on a moving direction and position of the pedestrian PD.

If the controller 512 determines that the pedestrian PD is laterally crossing the frontal area ahead of the vehicle V, based on the data on the moving direction and position of the pedestrian PD thus acquired, the controller 512 may determine that the pedestrian PD is crossing the road.

If the controller 512 determines that the pedestrian PD is crossing the road, the controller 512 may send the headlight 300 the data indicating that the headlight 300 directed toward the pedestrian PD is to be repeatedly switched between the high beam HB and the low beam LB at a constant frequency.

### Memory 520

The memory 520 may include, for example, a read only memory (ROM) and a random-access memory (RAM), and the ROM may hold the control program for the processor 510.

The memory 520 may include a storage 521 as the RAM.

The storage 521 may hold the control program for the processor 510.

The data acquired from the frontal imager 100 and the driver imager 200 may be stored in the storage 521.

### Workings and Effects

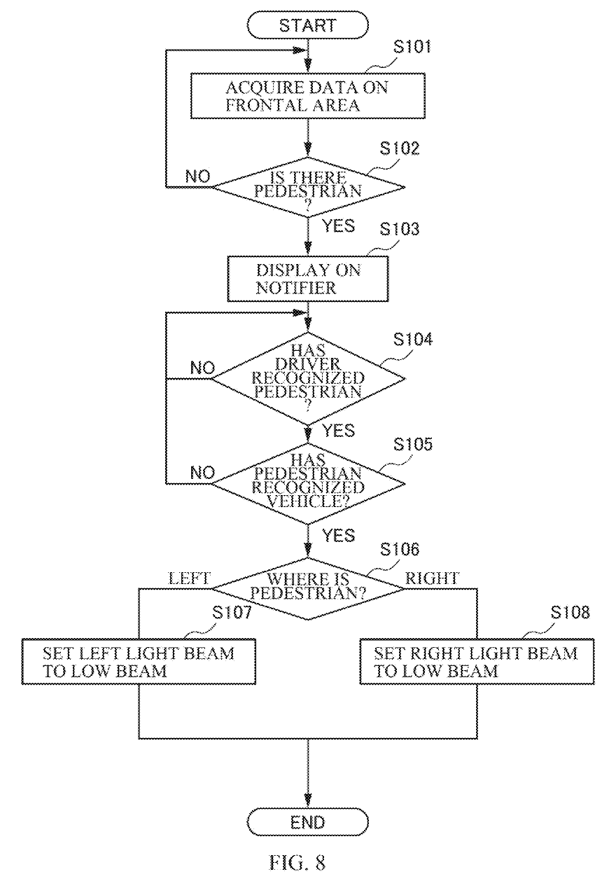

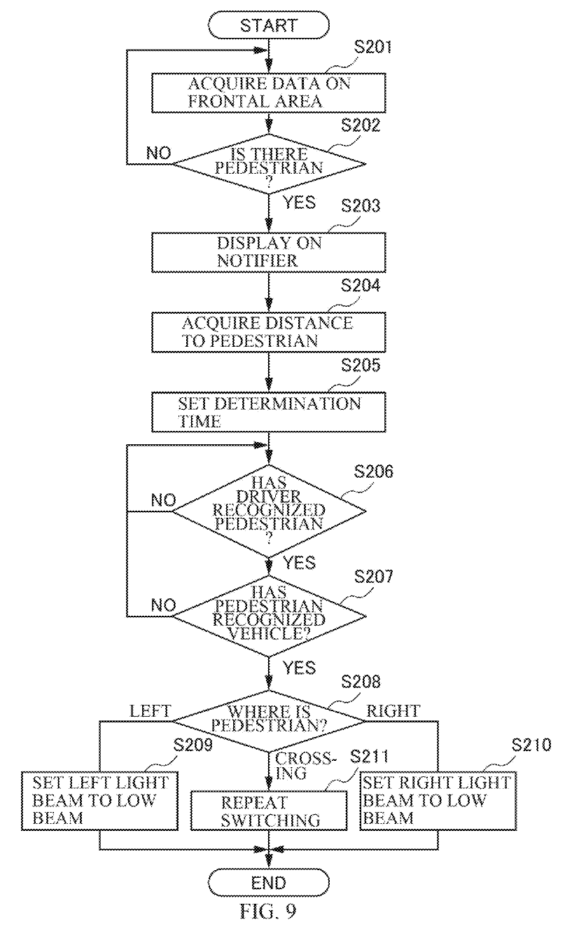

A description is given, with reference to FIGS. 8 and 9, of exemplary workings of the headlight control apparatus 10 according to the present example embodiment having the configuration described above and a process to be performed by the headlight controller 500.

### Process by Headlight Controller 500

After the driver P starts preparing to travel the vehicle V, as illustrated in FIG. 8, the data obtainer 511 may acquire the image data on the frontal area ahead of the vehicle V from the frontal imager 100 and store the data thus acquired in the memory 520 (Step S101).

The controller 512 may acquire the data received from the frontal imager 100 from the memory 520, and determine whether the pedestrian PD is present in the frontal area (Step S102).

If the controller 512 does not determine that the pedestrian PD is present in the frontal area (Step S102: NO), the controller 512 may return the process to Step S101.

In contrast, if the controller 512 determines that the pedestrian PD is present in the frontal area (Step S102: YES), the controller 512 may cause the notifier 400 to display a notification indicating that the pedestrian PD is present in the frontal area (Step S103).

Thereafter, the controller 512 may cause the process to proceed to Step S104.

The controller 512 may acquire the data received from the driver imager 200 from the memory 520, and determine whether the driver P has recognized the pedestrian PD (Step S104).

In some embodiments, the controller 512 may determine that the driver P has recognized the pedestrian PD if the controller 512 determines that the line of sight of the driver P is directed toward the pedestrian PD or that the line of sight of the driver P has shifted from the notifier 400 to the frontal area.

If the controller 512 determines that the driver P has recognized the pedestrian PD (Step S104: YES), the controller 512 may cause the process to proceed to Step S105.

In contrast, if the controller 512 does not determine that the driver P has recognized the pedestrian PD (Step S104: NO), the controller 512 may return the process to Step S104.

The controller 512 may acquire the data received from the frontal imager 100 from the memory 520, and determine whether the pedestrian PD has recognized the vehicle V (Step S105).

In some embodiments, the controller 512 may determine that the pedestrian PD has recognized the vehicle V if the face of the pedestrian PD is directed toward the vehicle V or if the pedestrian PD moves toward a road end, for example.

If the controller 512 determines that the pedestrian PD has recognized the vehicle V (Step S105: YES), the controller 512 may cause the process to proceed to Step S106.

In contrast, if the controller 512 does not determine that the pedestrian PD has recognized the vehicle V (Step S105: NO), the controller 512 may return the process to Step S104.

The controller 512 may determine whether the pedestrian PD is on a right side or a left side of the vehicle V (Step S106).

If the controller 512 determines that the pedestrian PD is on the left side of the vehicle V (Step S106: LEFT), the controller 512 may send the headlight 300 the data indicating that the left irradiation beam BM1L is to be set to the low beam LB (Step S107), and end the process.

If the controller 512 determines that the pedestrian PD is on the right side of the vehicle V (Step S106: RIGHT), the controller 512 may send the headlight 300 the data indicating that the right irradiation beam BM1R is to be set to the low beam LB (Step S108), and end the process.

As described above, if the headlight controller 500 determines that the driver P has recognized the pedestrian PD, based on the data acquired from the frontal imager 100 and that the pedestrian PD has recognized the vehicle V, based on the data acquired from the driver imager 200, the headlight controller 500 may set the left irradiation beam BM1L and the right irradiation beam BM1R of the headlight 300 directed toward the pedestrian PD to the low beam LB.

### Process by Headlight Controller 500 Based on Data on Frontal Area

After the driver P starts preparing to travel the vehicle V, as illustrated in FIG. 9, the data obtainer 511 may acquire the data on the frontal area ahead of the vehicle V from the frontal imager 100 and store the data thus acquire in the memory 520 (Step S201).

The controller 512 may acquire the data received from the frontal imager 100 from the memory 520, and determine whether the pedestrian PD is present in the frontal area (Step S202).

If the controller 512 does not determine that the pedestrian PD is present in the frontal area (Step S202: NO), the controller 512 may return the process to Step S201.

In contrast, if the controller 512 determines that the pedestrian PD is present in the frontal area (Step S202: YES), the controller 512 may cause the notifier 400 to display the notification indicating that the pedestrian PD is present in the frontal area (Step S203), and cause the process to proceed to Step S204.

Based on the data acquired from the frontal imager 100, the controller 512 may acquire the data on the distance between the pedestrian PD and the vehicle V (Step S204), and cause the process to proceed to Step S205.

Based on the distance between the pedestrian PD and the vehicle V, the controller 512 may set the determination time T, which is the time in which it is determined whether the line of sight of the driver P is directed toward the pedestrian PD (Step S205), and cause the process to proceed to Step S206.

The controller 512 may acquire the data received from the driver imager 200 from the memory 520, and determine whether the driver P has recognized the pedestrian PD (Step S206).

If the controller 512 determines that the driver P has recognized the pedestrian PD (Step S206: YES), the controller 512 may cause the process to proceed to Step S207.

In contrast, if the controller 512 does not determine that the driver P has recognized the pedestrian PD (Step S206: NO), the controller 512 may return the process to Step S206.

The controller 512 may acquire the data received from the frontal imager 100 from the memory 520, and determine whether the pedestrian PD has recognized the vehicle V (Step S207).

If the controller 512 determines that the pedestrian PD has recognized the vehicle V (Step S207: YES), the controller 512 may cause the process to proceed to Step S208.

In contrast, if the controller 512 does not determine that the pedestrian PD has recognized the vehicle V (Step S207: NO), the controller 512 may return the process to Step S206.

The controller 512 may determine a position of the pedestrian PD in the frontal area (Step S208).

If the controller 512 determines that the pedestrian PD is on the left side of the vehicle V (Step S208: LEFT), the controller 512 may send the headlight 300 the data indicating that the left irradiation beam BM1L is to be set to the low beam LB (Step S209), and end the process.

If the controller 512 determines that the pedestrian PD is on the right side of the vehicle V (Step S208: RIGHT), the controller 512 may send the headlight 300 the data indicating that the right irradiation beam BM1R is to be set to the low beam LB (Step S210), and end the process.

When the controller 512 determines that the pedestrian PD is crossing the road (Step S208: CROSSING), the controller 512 may send the headlight 300 the data indicating that the front irradiation beam BM2 (the front irradiation beams BM2L and BM2R) of the headlight 300 directed toward the pedestrian PD is to be set to the low beam LB.

Thereafter, the controller 512 may send the headlight 300 the data indicating that switching between the high beam HB and the low beam LB is to be performed at a constant frequency (Step S211), and end the process.

As described above, the headlight controller 500 may control the headlight 300 in accordance with the condition in front of the vehicle V.

Based on the data acquired from the frontal imager 100 or the data acquired from the driver imager 200, the headlight controller 500 may set the determination time T in accordance with the distance between the vehicle V and the pedestrian PD.

If the headlight controller 500 determines that the driver P has recognized the pedestrian PD and that the pedestrian PD has recognized the vehicle V, the headlight controller 500 may set the left irradiation beam BM1L or the right irradiation beam BM1R of the headlight 300 directed toward the pedestrian PD to the low beam LB.

If the headlight controller 500 determines that the pedestrian PD is crossing the road, the controller 512 may set the headlight 300 directed toward the pedestrian PD to the low beam LB.

Thereafter, the controller 512 may send the headlight 300 the data indicating that switching between the high beam HB and the low beam LB is to be repeated at a constant frequency.

As described above, the headlight control apparatus 10 according to the present example embodiment is configured to irradiate the frontal area ahead of the vehicle V including the headlight control apparatus 10. The headlight control apparatus 10 includes the frontal imager 100, the driver imager 200, the headlight 300, and the headlight controller 500. The frontal imager 100 is configured to monitor a pedestrian PD and a structure present in the frontal area. The driver imager 200 is configured to recognize a line of sight of a driver P who drives the vehicle V. The headlight 300 is configured to emit irradiation beams irradiating different directions at the same time and each switchable between the high beam HB and the low beam LB. The headlight controller 500 is configured to acquire data from the frontal imager 100 and data from the driver imager 200, and control the headlight 300, based on the data acquired from the frontal imager 100 and the data acquired from the driver imager 200. When the headlight controller 500 determines that the line of sight of the driver P is directed toward the pedestrian PD, based on the data acquired from the driver imager 200, and that the pedestrian PD has recognized the vehicle V, based on the data acquired from the frontal imager 100, or when the headlight controller 500 determines that the line of sight of the driver P has shifted from the notifier 400 to the frontal area, based on the data acquired from the driver imager 200 and that the pedestrian PD has recognized the vehicle V, based on the data acquired from the frontal imager 100, the headlight controller 500 sets the headlight 300 directed toward the pedestrian PD to the low beam LB.

That is, when the headlight controller 500 determines that the driver P has recognized the pedestrian PD and that the pedestrian PD has recognized the vehicle V, the headlight controller 500 sets the left irradiation beam BM1L or the right irradiation beam BM1R whichever to be emitted in a direction in which the pedestrian PD is present to the low beam LB.

Accordingly, when the headlight control apparatus 10 determines that the driver P and the pedestrian PD have recognized each other's presence, the headlight control apparatus 10 makes it possible to suppress dazzling of the pedestrian PD caused by the irradiation beam from the headlight 300 by setting the irradiation beam of the headlight in the direction in which the pedestrian PD is present to the low beam LB.

It is therefore possible to suppress unnecessary irradiation toward the pedestrian present in the frontal area in the night and secure safety for the movement of the pedestrian.

According to the headlight control apparatus 10 of the present example embodiment, the headlight controller 500 may acquire the data on the distance between the pedestrian PD and the vehicle V, based on the data acquired from the frontal imager 100, and set the determination time T, in accordance with the distance between the pedestrian PD and the vehicle V. The determination time T may be time in which a determination is made as to whether the line of sight of the driver P is directed toward the pedestrian PD or time in which a determination is made as to whether the line of sight of the driver P has shifted from the notifier 400 to the frontal area.

That is, based on the data acquired from the frontal imager 100, the controller 512 may acquire the data on the distance between the vehicle V and the pedestrian PD, and set the determination time T in accordance with the distance between the vehicle V and the pedestrian PD.

The controller 512 may determine whether the line of sight of the driver P is directed toward the pedestrian PD or whether the line of sight of the driver P has shifted from the notifier 400 to the frontal area in the determination time T thus set.

Thereafter, when the controller 512 determines that the line of sight of the pedestrian PD is directed toward the pedestrian PD or that the line of sight of the driver P has shifted from the notifier 400 to the frontal area, the controller 512 may send the headlight 300 the data indicating that the headlight 300 directed toward the pedestrian PD is to be set to the low beam LB.

Accordingly, when the driver P of the vehicle V has recognized the presence of the pedestrian PD in the frontal area, the headlight control apparatus 10 makes it possible to suppress dazzling of the pedestrian PD caused by an irradiation beam from the headlight further earlier by setting the determination time T in accordance with the distance between the vehicle V and the pedestrian PD and setting an irradiation beam of the headlight in the direction in which the pedestrian PD is present to the low beam LB.

It is therefore possible to suppress unnecessary irradiation toward the pedestrian present in the frontal area in the night and secure safety for the movement of the pedestrian.

According to the headlight control apparatus 10 of the present example embodiment, when the headlight controller 500 determines that the pedestrian PD is crossing the road, based on the data acquired from the frontal imager 100, the headlight controller 500 may switch the headlight 300 directed toward the pedestrian PD to the low beam LB, and thereafter repeatedly switch the headlight 300 between the high beam HB and the low beam LB at a constant frequency.

That is, the controller 512 may analyze the image data received from the frontal imager 100 to acquire the data on a moving direction and position of the pedestrian PD.

If the controller 512 determines that the pedestrian PD is laterally crossing the frontal area ahead of the vehicle V, based on the data on the moving direction and position of the pedestrian PD thus acquired, the controller 512 may determine that the pedestrian PD is crossing the road.

When the controller 512 determines that the pedestrian PD is crossing the road, the controller 512 may send the headlight 300 the data indicating that the headlight 300 directed toward the pedestrian PD is to be repeatedly switched between the high beam HB and the low beam LB at a constant frequency.

Accordingly, when it is determined that the pedestrian PD is crossing the road, it is possible for the headlight control apparatus 10 to urge the pedestrian PD to recognize the vehicle V earlier by repeatedly switching the headlight 300 directed toward the pedestrian PD between the high beam HB and the low beam LB at a constant frequency.

It is therefore possible to suppress unnecessary irradiation toward the pedestrian present in the frontal area in the night and secure safety for the movement of the pedestrian.

### Second Example Embodiment

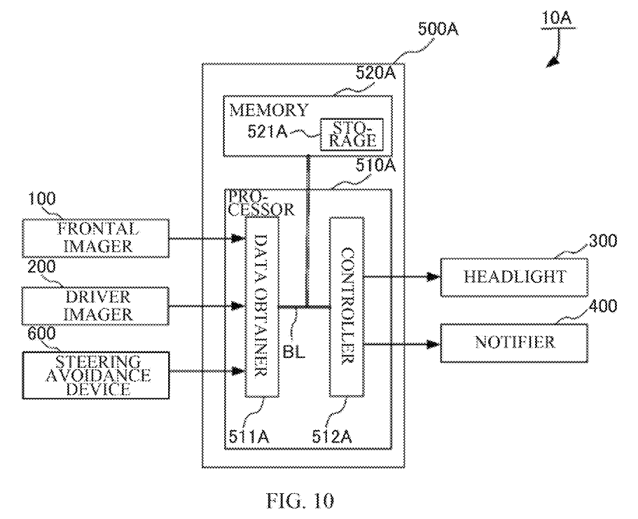

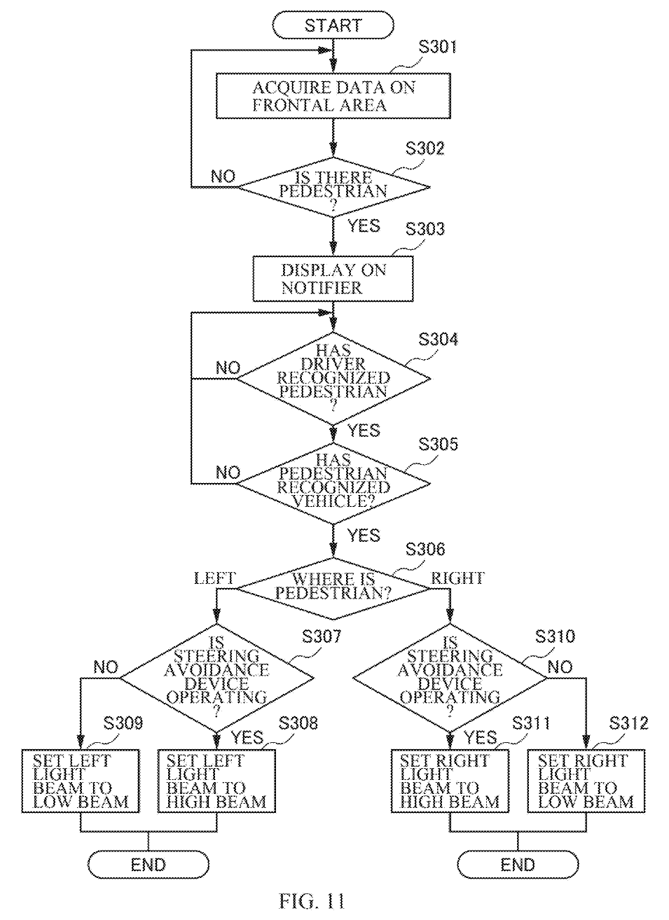

A description is given, with reference to FIGS. 10 and 11, of a headlight control apparatus 10A according to the present example embodiment.

### Headlight Control Apparatus 10A

As illustrated in FIG. 10, the headlight control apparatus 10A may include the frontal imager 100, the driver imager 200, the headlight 300, the notifier 400, a headlight controller 500A, and a steering avoidance device 600.

The frontal imager 100, the driver imager 200, the headlight 300, the notifier 400, and the steering avoidance device 600 may be coupled to the headlight controller 500.

### Headlight Controller 500A

The headlight controller 500A may include one or more processors 510A and one or more memories 520 communicably coupled to the one or more processors 510.

The processor 510A and the memory 520 may be coupled to each other with a bus line BL.

The processor 510A may control the headlight 300, based on a control program held in the memory 520.

### Processor 510A

The processor 510A may include a data obtainer 511A and a controller 512A.

The data obtainer 511A, the controller 512A, and the memory 520A may be coupled to one another with the bus line BL.

The data obtainer 511A may acquire data from the frontal imager 100, the driver imager 200, and the steering avoidance device 600, and store the data thus acquired in the memory 520.

The data obtainer 511A may be coupled to the frontal imager 100 and the driver imager 200.

The controller 512A may determine whether the steering avoidance device 600 is operating, based on the data acquired from the steering avoidance device 600.

In some embodiments, the controller 512A may determine that the steering avoidance device 600 is operating upon acquiring data indicating that the vehicle V is to avoid an obstacle or a pedestrian PD in the frontal area ahead of the vehicle V from the steering avoidance device 600.

When the controller 512A determines that the steering avoidance device 600 is operating, the controller 512A may send the headlight 300 the data indicating that the headlight 300 directed toward the pedestrian PD is to be set to the high beam HB.

### Memory 520A

The memory 520A may include, for example, a read only memory (ROM) and a random-access memory (RAM), and the ROM may hold the control program for the processor 510A.

The memory 520A may include a storage 521A as the RAM.

The storage 521A may hold the control program for the processor 510.

The data acquired from the frontal imager 100, the driver imager 200, and the steering avoidance device 600 may be stored in the storage 521A.

### Steering Avoidance Device 600

Based on data acquired from a non-illustrated vehicle control apparatus mounted in the vehicle V and configured to achieve automated driving, the steering avoidance device 600 may cause the vehicle V to automatically avoid approaching the obstacle or the pedestrian PD by controlling a steering operation or a traveling speed of vehicle V.

The vehicle control apparatus may be coupled to the frontal imager 100, and acquire data on the distance from the frontal imager 100 to the obstacle or the pedestrian PD.

If the vehicle control apparatus determines that the vehicle V will approach the obstacle or the pedestrian PD, based on the data on the distance to the obstacle or the pedestrian PD, the vehicle control apparatus may send the steering avoidance device 600 data indicating that the steering operation or the traveling speed of the vehicle V is to be controlled, and the steering avoidance device 600 may cause the vehicle V to automatically avoid approaching the obstacle or the pedestrian PD.

At this time, the steering avoidance device 600 may send the controller 512A data indicating that the vehicle V is to avoid the obstacle or the pedestrian PD.

The controller 512A determines that the steering avoidance device 600 is operating upon receiving the data indicating the vehicle V is to avoid approaching the obstacle or the pedestrian PD from the steering avoidance device 600.

Based on the determination that the steering avoidance device 600 is operating, the controller 512A may send the headlight 300 the data indicating that the headlight 300 directed toward the pedestrian PD is to be set to the high beam HB.

### Workings and Effects

A description is given, with reference to FIG. 11, of exemplary workings of the headlight control apparatus 10A according to the present example embodiment having the configuration described above and process to be performed by the headlight controller 500A.

### Process by Headlight Controller 500A

As illustrated in FIG. 11, the data obtainer 511A may acquire the data from the frontal imager 100, and store the data thus acquired in the memory 520 (Step S301).

The controller 512A may acquire the data received from the frontal imager 100 from the memory 520, and determine whether the pedestrian PD is present in the frontal area ahead of the vehicle V (Step S302).

If the controller 512A does not determine that the pedestrian PD is present in the frontal area (Step S302: NO), the controller 512A may return the process to Step S301.

In contrast, if the controller 512A determines that the pedestrian PD is present in the frontal area (Step S302: YES), the controller 512A may cause the notifier 400 to display the notification indicating the pedestrian PD is present in the frontal area (Step S303).

Thereafter, the controller 512A may cause the process to proceed to Step S304.

The controller 512 may acquire the data received from the driver imager 200 from the memory 520, and determine whether the driver P has recognized the pedestrian PD (Step S304).

In some embodiments, the controller 512A may determine that the driver P has recognized the pedestrian PD if the controller 512A determines that the line of sight of the driver P is directed toward the pedestrian PD or that the line of sight of the driver P has shifted from the notifier 400 to the frontal area.

If the controller 512A determines that the driver P has recognized the pedestrian PD (Step S304: YES), the controller 512 may cause the process to proceed to Step S305.

In contrast, if the controller 512 does not determine that the driver P has recognized the pedestrian PD (Step S304: NO), the controller 512 may return the process to Step S304.

The controller 512A may acquire the data received from the frontal imager 100 from the memory 520A, and determine whether the pedestrian PD has recognized the vehicle V (Step S305).

If the controller 512A determines that the pedestrian PD has recognized the vehicle V (Step S305: YES), the controller 512A may cause the process to proceed to Step S306.

In contrast, if the controller 512A does not determine that the pedestrian PD has recognized the vehicle V (Step S305: NO), the controller 512A may return the process to Step S304.

The controller 512A may determine whether the pedestrian PD is on a right side or a left side of the vehicle V (Step S306).

If the controller 512A determines that the pedestrian PD is on the left side of the vehicle V (Step S306: LEFT), the controller 512A may determine whether the steering avoidance device 600 is operating (Step S307).

Here, the controller 512A may determine that the steering avoidance device 600 is operating upon receiving the data indicating that the vehicle V is to avoid approaching the obstacle or the pedestrian PD from the steering avoidance device 600.

If the controller 512A determines that the steering avoidance device 600 is operating (Step S307: YES), the controller 512A may set the left irradiation beam BM1L to the high beam HB (Step S308), and end the process.

In contrast, if the controller 512A does not determine that the steering avoidance device 600 is operating (Step S307: NO), the controller 512A may set the left irradiation beam BM1L to the low beam LB (Step S309), and end the process.

If the controller 512A determines that the pedestrian PD is on the right side of the vehicle V (Step S306: RIGHT), the controller 512A may determine whether the steering avoidance device 600 is operating (Step S310).

If the controller 512A determines that the steering avoidance device 600 is operating (Step S310: YES), the controller 512A may set the right irradiation beam BM1R to the high beam HB (Step S311), and end the process.

In contrast, if the controller 512A does not determine that the steering avoidance device 600 is operating (Step S310: NO), the controller 512A may set the right irradiation beam BM1R to the low beam LB (Step S312), and end the process.

As described above, if the headlight controller 500A determines that the steering avoidance device 600 is operating when the headlight controller 500A determines, based on the data acquired from the frontal imager 100, that the driver P has recognized the pedestrian PD and that the pedestrian PD has recognized the vehicle V, the headlight controller 500 may set the headlight 300 directed toward the pedestrian PD to the high beam HB.

It is to be noted that, when the headlight controller 500A in the headlight control apparatus 10A determines that the steering avoidance device 600 is operating, the headlight controller 500A may set the headlight 300 directed toward the pedestrian PD to the high beam HB without determining whether the driver P has recognized the pedestrian PD.

As described above, the headlight control apparatus 10A according to the present example embodiment may include the steering avoidance device 600 that causes the vehicle V to automatically avoid approaching the pedestrian PD when the pedestrian PD comes closer to the vehicle V, and the headlight controller 500A may set the headlight 300 directed toward the pedestrian PD to the high beam HB when the steering avoidance device 600 is operating.

That is, the controller 512A may determine that the steering avoidance device 600 is operating upon receiving the data indicating that the vehicle V is to avoid the obstacle present in the frontal area from the steering avoidance device 600.

When the controller 512A determines that the steering avoidance device 600 is operating, the controller 512A may send the headlight 300 the data indicating that the headlight 300 directed toward the pedestrian PD is to be set to the high beam HB.

Accordingly, when the headlight control apparatus 10A determines that the steering avoidance device 600 is operating, the headlight control apparatus 10A may set the headlight 300 directed toward the pedestrian PD to the high beam HB. It is therefore possible for the headlight control apparatus 10A to urge the pedestrian PD to recognize the vehicle V earlier, and to operate the steering avoidance device 600 more accurately.

This makes it possible to secure safety for the movement of the pedestrian present in the frontal area in the night.

The foregoing descriptions of the headlight control apparatuses 10 and 10A have been given with reference to the examples in which the pedestrian PD is present in the frontal area ahead of the vehicle V; however, the example may be replaced with an example in which a bicycle is present in the frontal area ahead of the vehicle V.

In some embodiments, a program that causes the process to be performed by the headlight controller 500 or 500A may be recorded on a non-transitory recording medium readable by a computer system. The headlight control apparatus 10 or 10A according to the example embodiment of the disclosure may be implemented by causing the headlight controller 500 or 500A to load the program recorded in the non-transitory recording medium and causing the computer system to execute the program.

The computer system as used herein may encompass an operating system (OS) and hardware such as a peripheral device.

The "computer system" may encompass a website providing environment or a website displaying environment, when the computer system utilizes a World Wide Web (WWW) system.

The program may be transmitted from the computer system that contains the program in a device such as a storage device to another computer system via a transmission medium or by a carrier wave in a transmission medium.

The "transmission medium" designed to transmit the program may refer to a medium having a capability to transmit data, including: a network or a communication network such as the Internet; and a communication link or a communication line such as a telephone line.

The program may be directed to implement a part of the operation described above.

The program may be a so-called differential file or differential program designed to implement the operation by a combination of the program already recorded on the computer system.

Although some embodiments of the disclosure have been described in detail with reference to the accompanying drawings, all headlight control apparatuses implementable through design modifications appropriately made by those skilled in the art based on the headlight control apparatuses 10 and 10A according to the foregoing example embodiments of the disclosure also fall within the scope of the disclosure as long as they include the gist of the disclosure.

Those skilled in the art can conceive of various modifications and alterations within the scope of the inventive concept of the disclosure, and it is understood that these modifications and alterations also fall within the scope of the disclosure.

For example, those skilled in the art may add some constituent elements to, delete some constituent elements from, or make some design modifications to the foregoing example embodiments as appropriate, or add some steps to, remove some steps from, or make some modifications to conditions of the foregoing example embodiments as appropriate. These embodiments are also included in the scope of the disclosure as long as they include the gist of the disclosure.

Further, it will be understood that other workings and effects than those provided by the foregoing example embodiments and apparent from the description herein or appropriately conceivable by those skilled in the art are naturally provided by the disclosure.

Various embodiments of the disclosure may be provided by appropriately combining the constituent elements disclosed in the foregoing example embodiments.

For example, some constituent elements may be deleted from all the constituent elements disclosed in the foregoing example embodiments.

Furthermore, constituent elements across different embodiments may be combined as appropriate.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims. The limitations in the claims are to be interpreted broadly based on the language employed in the claims and not limited to examples described in this specification or during the prosecution of the application, and the examples are to be construed as non-exclusive. As used in this specification and the appended claims, the singular forms "a," "an," and "the" include, especially in the context of the claims, are to be construed to cover both the singular and the plural, unless otherwise indicated herein or clearly contradicted by context. Throughout this specification and the appended claims, unless the context requires otherwise, the terms "comprise", "include", "have", and their variations are to be construed to cover the inclusion of a stated element, integer, or step but not the exclusion of any other non-stated element, integer, or step. The use of the terms first, second, etc. does not denote any order or importance, but rather the terms first, second, etc. are used to distinguish one element from another. The term "disposed on/ provided on/ formed on" and its variants having the similar meaning thereto as used herein refer to elements disposed directly in contact with each other or indirectly by having intervening structures therebetween.

One or both of the headlight controllers 500 and 500A illustrated in FIGS. 1, 3, 4A, 4B, 7,and 10, are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the headlight controllers 500 and 500A illustrated in FIGS. 1, 3, 4A, 4B, 7,and 10,. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the headlight controllers 500 and 500A illustrated in FIGS. 1, 3, 4A, 4B, 7,and 10,.

According to the one or more example embodiments of the disclosure described above, it is possible to suppress unnecessary irradiation toward a pedestrian present in a frontal area in the night and secure safety for movement of the pedestrian.

1. A headlight control apparatus configured to be applied to a vehicle, the headlight control apparatus comprising:
a frontal imager configured to monitor a pedestrian and a structure present in a frontal area ahead of the vehicle;
a driver imager configured to recognize a line of sight of a driver who drives the vehicle;
one or more headlights configured to irradiate the frontal area by emitting irradiation beams irradiating different directions at a same time, the irradiation beams being switchable between a high beam and a low beam;
a notifier configured to notify the driver that the pedestrian has been detected in the frontal area; and
a headlight controller configured to control the one or more headlights and the notifier, based on data acquired from the frontal imager and data acquired from the driver imager, wherein
the headlight controller is configured to,
when the headlight controller determines that the line of sight of the driver is directed toward the pedestrian, based on the data acquired from the driver imager, and that the pedestrian has recognized the vehicle, based on the data acquired from the frontal imager, or
when the headlight controller determines that the line of sight of the driver has shifted from the notifier to the frontal area, based on the data acquired from the driver imager, and that the pedestrian has recognized the vehicle, based on the data acquired from the frontal imager,
set an irradiation beam of any headlight directed toward the pedestrian out of the one or more headlights to the low beam.

2. The headlight control apparatus according to claim 1, wherein
the headlight controller is configured to acquire data on a distance between the pedestrian and the vehicle, based on the data acquired from the frontal imager, and set determination time in accordance with the distance between the pedestrian and the vehicle, the determination time comprising time in which a determination is made as to whether the line of sight of the driver is directed toward the pedestrian or time in which a determination is made as to whether the line of sight of the driver has shifted from the notifier to the frontal area.

3. The headlight control apparatus according to claim 1, wherein
the headlight controller is configured to, when the headlight controller determines that the pedestrian is crossing a road, based on the data acquired from the frontal imager, switch the irradiation beam of the headlight directed toward the pedestrian to the low beam and thereafter repeatedly switch the irradiation beam of the headlight directed toward the pedestrian between the high beam and the low beam at a constant frequency.

4. The headlight control apparatus according to claim 2, wherein
the headlight controller is configured to, when the headlight controller determines that the pedestrian is crossing a road, based on the data acquired from the frontal imager, switch the irradiation beam of the headlight directed toward the pedestrian to the low beam and thereafter repeatedly switch the irradiation beam of the headlight directed toward the pedestrian between the high beam and the low beam at a constant frequency.

5. The headlight control apparatus according to claim 1, further comprising
a steering avoidance device configured to cause the vehicle to automatically avoid approaching the pedestrian when the pedestrian comes closer to the vehicle, wherein
the headlight controller is configured to, when the steering avoidance device is operating, set the irradiation beam of the headlight directed toward the pedestrian to the high beam.

6. The headlight control apparatus according to claim 2, further comprising
a steering avoidance device configured to cause the vehicle to automatically avoid approaching the pedestrian when the pedestrian comes closer to the vehicle, wherein
the headlight controller is configured to, when the steering avoidance device is operating, set the irradiation beam of the headlight directed toward the pedestrian to the high beam.

7. A headlight control apparatus configured to be applied to a vehicle, the headlight control apparatus comprising:
a frontal imager configured to monitor a pedestrian and a structure present in a frontal area ahead of the vehicle;
a driver imager configured to recognize a line of sight of a driver who drives the vehicle;
one or more headlights configured to irradiate the frontal area by emitting irradiation beams irradiating different directions at a same time, the irradiation beams being switchable between a high beam and a low beam;
a notifier configured to notify the driver that the pedestrian has been detected in the frontal area; and
a headlight controller configured to control the one or more headlights and the notifier, based on data acquired from the frontal imager and data acquired from the driver imager, wherein
the headlight controller comprises one or more processors and one or more memories communicably coupled to the one or more processors,
the one or more memories comprise a storage configured to store the data acquired from the frontal imager and the data acquired from the driver imager, and
the one or more processors are configured to,
when the headlight controller determines that the line of sight of the driver is directed toward the pedestrian, based on the data acquired from the driver imager, and that the pedestrian has recognized the vehicle, based on the data acquired from the frontal imager, or
when the headlight controller determines that the line of sight of the driver has shifted from the notifier to the frontal area, based on the data acquired from the driver imager, and that the pedestrian has recognized the vehicle, based on the data acquired from the frontal imager,
set an irradiation beam of any headlight directed toward the pedestrian out of the one or more headlights to the low beam.
